(19) United States
(12) Patent Application Publication
(10) Pub. No.: US 2005/0092794 A1
(43) Pub. Date: May 5, 2005

(54) Non-slip vehicle article container

(76) Inventor: Linda Ashley, Hopkinton, MA (US)

Correspondence Address: LINDA ASHLEY, 31 ALEXANDER ROAD, HOPKINTON, MA, 01748, US

(21) Appl. No.: 10/701,964

(22) Filed: Nov. 5, 2003

(51) Int. Cl. B60R 7/00

(52) U.S. Cl. 224/275

(57) ABSTRACT

A moveable vehicle accessory organizer consisting of a low profile container (10) with a structured resilient sheet gripping base (20) and adhesive attachment means (30). Console characteristics are optimized to eliminate sliding within the vehicle due to inertial forces, without requiring the use of straps or features that restrict convenient repositioning of the console.

### BACKGROUND OF THE INVENTION

1. Field of the Invention

This invention relates to a removable tray or console used to secure and organize accessories and goods in an automobile or other vehicle.

2. Description of Background and Relevant Information

Aftermarket devices commonly called consoles provide compartments to conveniently store goods and materials such as cups, music CDs and other accessories. An automobile creates a dynamic internal environment subject to G-forces from acceleration, turns and stops. Drivers carry a variety of paraphernalia on car seats. Spilling drinks or falling articles are a significant source of hazardous distraction. According to the NHTSA (Ranney, Mazzae, Garrott, Goodman 2000), driver distraction accounts for approximately 25% of automobile accidents.

Consoles may be secured in this dynamic environment by several means. Motion restriction mechanisms include providing sharp teeth or edges that dig into the placement surface, straps that wrap around a seat, restraint with the automotive seatbelt, tongues that jam in the crack below the seatback, shaping which conforms to typical seat forms and fixed hard mounting with screws. U.S. Patents that illustrate these techniques include Gignac Pat. No. 5,915,777, Reed Pat. No. 2,633,180, Prees Pat. No. 3,338,629, and Griffith Pat. No. 5,560,676.

These mechanisms all have drawbacks. Consoles using sharp projections or edges may only be secure on the floor carpeting, leading to dangerous and distracting reaches down to retrieve items while driving. Hard projections also grip ineffectively on smooth surfaces and may injure seating surfaces. Straps or belts take time to connect and un-connect, making redeployment to accommodate passengers inconvenient. Tongues that jam between seat and seatback don't adapt to different crack dimensions and heights easily, and are no longer commercially successful. Hard mounted consoles are very difficult to install or removed.

Other mechanisms relevant to grip optimization of consoles covered in the art include use of “resilient coatings” and “bean bag” type bases that dynamically conform to the seat surface are described in Morris Pat. No. 3,083,998, Connell Pat. No. 3,304,143, Sikes Pat. No. 3,767,094 and Kopf Pat. No. 4,872,723. But none of the prior art either alone or considered in combination applies the major principles used to secure automobiles themselves to the road in order to allow the convenience of a strapless console while maximizing security of the console.

Racing cars maximize grip on a road surface by applying a number of principles. These include optimization of the contact patch, optimization of the contact material properties and surface structure, management of weight transfer, dynamic conformance to the road surface and minimization of loads on the contact surfaces. The embodiments of this invention described herein utilize all these principles to maximize grip on vehicle surfaces.

### BRIEF DESCRIPTION OF THE INVENTION

The invention is an organizer for storing accessories in vehicles, consisting of a container with a bottom surface designed to prevent slip, especially when used on vehicle seats. This organizer achieves the convenience of a strapless design with sufficient security for all normal driving conditions.

### OBJECTS AND ADVANTAGES

It is an object of the invention to grip securely to leather, vinyl or fabric vehicle seats.

It is an object of the invention to minimize dangerous driver distraction by placing and keeping accessories close at hand on a nearby vehicle seat.

It is an object of the invention to allow placement on fragile vehicle seating surfaces without causing marks or damage.

It is an object of the invention to allow rapid removal or repositioning of the organizer.

An advantage of the invention provides is suitability for most vehicle surfaces with minimal placement or form compatibility requirements.

It is an object of the invention to achieve these goals at low cost.

### BRIEF DESCRIPTION OF THE DRAWINGS

FIG. 1—An isometric view of the preferred embodiment of the device, situated on a vehicle seat.

FIG. 2—Side view of the preferred embodiment of the device.

FIG. 3—Side view of an embodiment of the device using a soft material layer to maximize conformance to seating surfaces.

FIG. 4—Side view of an embodiment of the device using a suspension layer to maximize conformance to seating surfaces and minimize shocks.

### REFERENCE NUMERALS IN DRAWINGS

| | |
|---|---|
| 10 | Injection molded plastic tray |
| 20 | PVC foam non-slip surface material |
| 30 | Adhesive |
| 40 | Soft open cell foam |
| 50 | Compliant cylindrical tubing |
| 70 | Vehicle seat |

### DETAILED DESCRIPTION OF THE PREFERRED EMBODIMENT

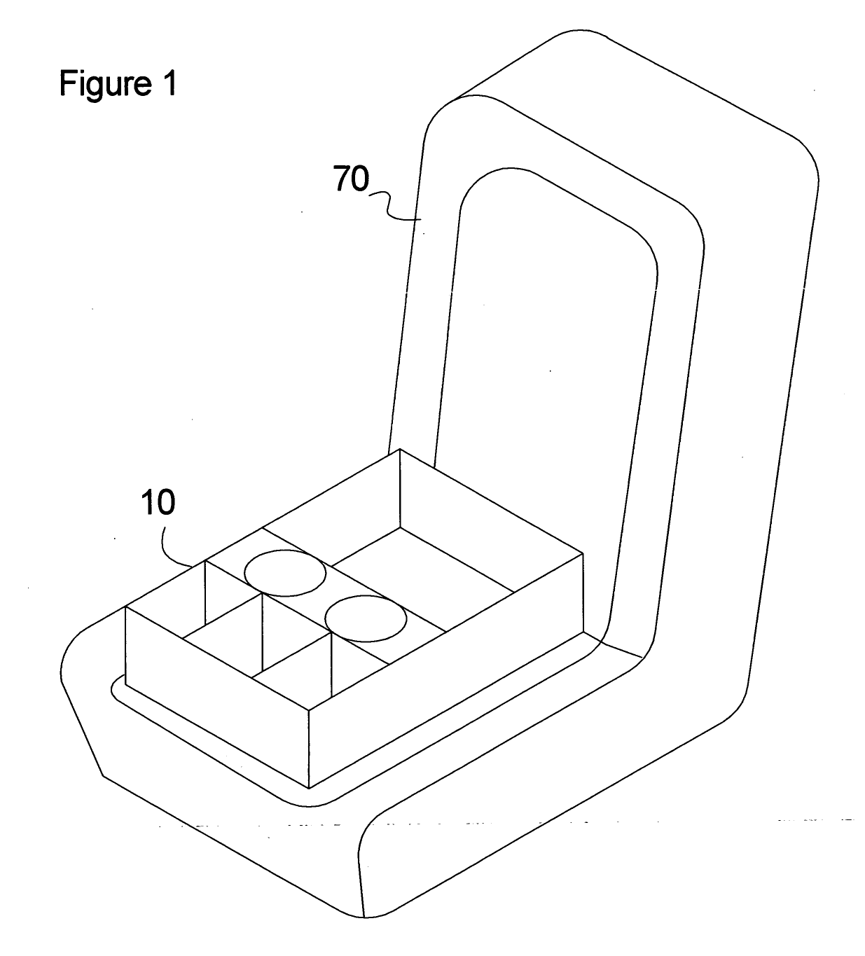

The preferred embodiment of the present invention is shown in FIG. 1. An injection molded plastic tray (10) provides various size compartments for storing beverage, electronic, cosmetic and food articles commonly utilized in vehicles. The organizer is optimized for placement on vehicle seats (70). Weight distribution within the tray is optimized for security by keeping the center of gravity of contained objects low and rearward. The tray design encourages this by placing holders for heavy and tall drinks in a centered position and the big compartment for larger and heavier items rearward. The profile of the console is also low and relatively long front to back to provide effective stabilization for maximum deceleration maneuvers.

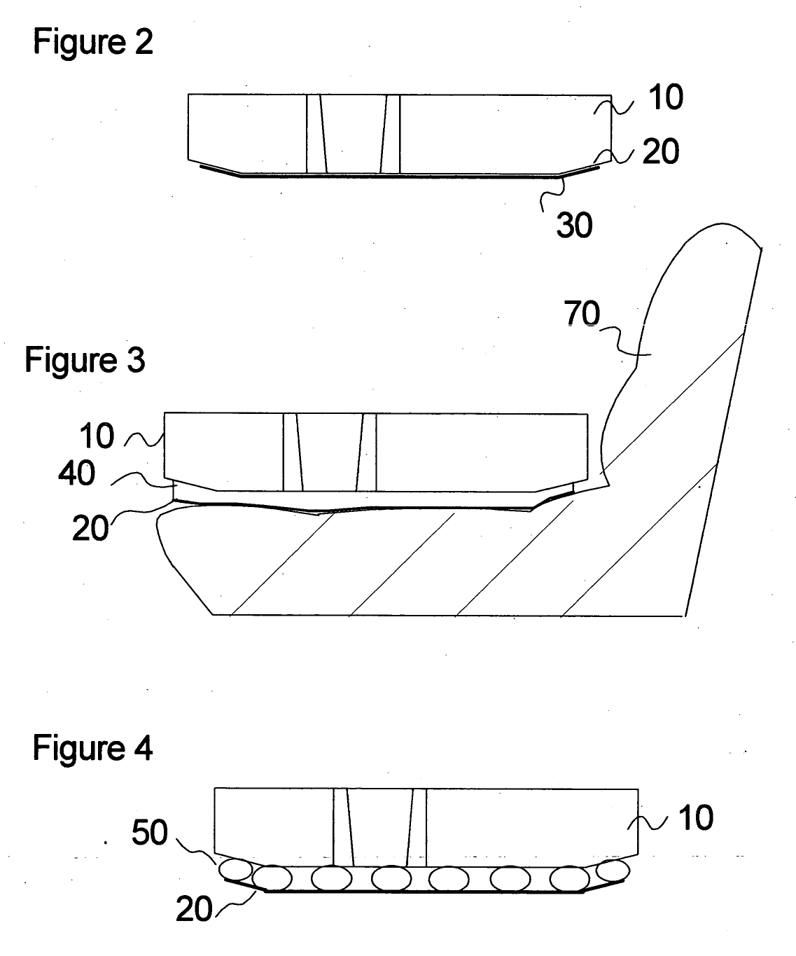

The bottom shape provides a large contact surface to maximize adhesion. The edges of the bottom surface are beveled as shown in the profile view of FIG. 2 to prevent weight transfer to a slick plastic edge and maximize grip. Beveled or cambered tires are commonly used in racing cars to maximize grip using a principle called “camber thrust”.

A specialized resilient material (20) is bonded to the bottom of the organizer with adhesive (30) to maximize the mechanical grip properties of the bottom surface. Through testing, a poly vinyl chloride (PVC) foam web sheet material was found to exhibit ideal grip characteristics on multiple surfaces such as leather, vinyl, fabric and carpeting. This material is commonly used for cushioning on shelves and is available from Kittrich Corp. of La Mirada, Calif. under the trademark name “Magic Cover”. This material was selected because it provides both a large-scale pattern similar to tire treads combined with a rough microstructure to optimize grip. “Resilient coatings” and “foam rubber”previously mentioned in the art do not provide an adequate levels of grip for reliable security, as is provided by this material. The PVC material may be bonded to the tray with contact adhesive, such as “Super 77” or “Scotch Grip” available from 3M Corp. of St. Paul, Minn.

Vehicles prevent loss of grip by minimizing load shift impacts within the vehicle and by using suspensions to limiting the maximal loads transmitted to the tires. Load shift within the preferred embodiment is prevented by using stabilizing spring like devices that adjust to the shape of beverages within the beverage holsters. Covering interior surfaces with the PVC foam material described above also minimizes slides and impact loads against the console walls.

Conformance of one surface to another is also very important in maximizing grip by maximizing the contact patch. The PVC foam material provides some compliance to match surface shapes. Further compliance is achieved as shown in FIG. 3 by the use of lightweight, soft open cell plastic foam material (40) and in FIG. 4 by the use of lightweight compliant cylindrical suspension elements (50).

Although the foam bottom material provides some shock cushioning, the further embodiments of FIG. 3 and 4 provide explicit shock absorbing suspension layers to minimize shock loads that could overwhelm the dynamic friction holding the organizer in place. The compliance and suspension layers also maintain contact with vehicle services under conditions of vibration, preventing a bounce creep movement.

### SUMMARY: RAMIFICATIONS AND SCOPE

Accordingly, significant improvements in vehicle occupant safety, organizer performance and convenience can result from use of the invention. The invention reduces driver distraction due to misplaced or fallen articles. The invention protects accessories from shock damage due to uncontrolled movement around the vehicle. The invention grips securely to a variety of seating surfaces and configurations. The invention is convenient to install, reposition and remove. The invention minimizes damage to seating surfaces. The invention can be produced inexpensively.

Although the descriptions above contain many specificities, these should not be construed as limiting the scope of the invention, but merely as providing illustrations of the some of the presently preferred embodiments of the invention. Thus the scope of the invention should be determined by the appended claims and their legal equivalents, rather than by the examples given.

1. A vehicle accessory organizer comprising:
(a) a container,
(b) a bottom surface of patterned resilient sheeting,
(c) and an attachment means for connecting said container and sheeting.

2. The container element of claim 1 wherein a plurality of compartments exists for holding different size items.

3. The container element of claim 2 wherein the compartments are designed by size and shape to encourage placement of heavier items in a center or rear position.

4. The container element of claim 2 wherein one or more container compartments has a closeable lid.

5. The resilient sheeting element of claim 1 wherein the resilient sheeting element is constructed with both large scale and micro scale grip-enhancing structure.

6. The resilient sheeting element of claim 1 wherein the resilient sheeting element consists of textured poly vinyl chloride material.

7. The attachment means of claim 1 wherein the attachment means consists of contact adhesive.

8. The container element of claim 1 wherein the container element is molded of plastic.

9. The container element of claim 1 where the bottom edges of the container are beveled to enhance grip.

10. A vehicle accessory organizer comprising:
(a) a container,
(b) a layer of compliant material,
(c) a bottom surface of patterned resilient sheeting,
(d) and an attachment means for connecting said container, compliant material and sheeting.

11. The resilient sheeting element of claim 10 wherein the resilient sheeting element consists of textured poly vinyl chloride material.

12. The compliant material element of claim 10 wherein the compliant material element consists of open cell plastic foam.

13. The compliant material element of claim 10 wherein the compliant material element consists of deformable resilient material structures.
